(19) United States
(12) Patent Application Publication
(10) Pub. No.: US 2007/0150280 A1
(43) Pub. Date: Jun. 28, 2007

(54) Interface System, Method and Apparatus

(75) Inventors: Deng-Jyi Chen, Hsinchu City (TW); Shih-Jung Peng, Hsinchu County (TW); Jan Karel Ruzicka Gonzalez, Moravia (CR)

Correspondence Address: LAW OFFICES OF LAI & ASSOCIATES, P.C., 5800 RANCHESTER, STE. 200, HOUSTON, TX, 77036, US

(73) Assignee: NATIONAL CHIAO TUNG UNIVERSITY, Hsinchu (TW)

(21) Appl. No.: 11/307,805

(22) Filed: Feb. 23, 2006

(30) Foreign Application Priority Data
Dec. 20, 2005 (TW) 094145357

(51) Int. Cl. G10L 21/00

(52) U.S. Cl. 704/270

(57) ABSTRACT

An interface system, a method and an apparatus are applied for an electronic apparatus and comprise a load module, an instruction database, a macro module, an object module, a command input module and a processing module. A recognition apparatus and an application program are loaded by the load module. A plurality of action instructions is stored in the instruction database and each one action instruction corresponds to an operation action of the application program. A plurality of macro instructions is set by the macro module in order to execute a group of operation actions of the application program. Each one macro instruction corresponds to one group of action instructions. The object module is used to configure a relative position of the application program to be an operation object controlled by the operation action. The command input module is coupled to the recognition apparatus for inputting an input command generated by the recognition apparatus recognizing an action signal. A action instruction corresponding to the input command is obtained by the processing module from the instruction database, a operation action corresponding to the action instruction is performed in the application program which has been loaded.

### FIELD OF THE INVENTION

This invention relates to an interface system, a method and an apparatus, and more particularly, to provide a visual user interface with simplification and effective operation for a user that integrates a recognition apparatus with an application program easily, hence the application program has an input function like the recognition apparatus.

### DESCRIPTION OF THE RELATED ART

Currently, if a recognition apparatus would like to integrate with an application program, the single application program must be directly integrated with a program of the recognition apparatus to form a single recognition application software system. Reference is made to FIG. 1, which depicts a schematic diagram showing a conventional recognition application software system. A recognition apparatus 11 is coupled to an application procedure call 14 of an application program 12 through a recognition interface layer 13, so as to form a recognition application software system. However, the above manner needs to face different application software for customization and the coupling between the user operation interface and application program has the following shortcomings:
(1) There is no generic user interface that provides a design environment for the recognition apparatus, so various application programs and the generic user interface may not exist in a same interface environment simultaneously.
(2) The difficulty in applying the application program to the recognition apparatus is to understand the low level programming, the knowledge background for the system design and obtain the source codes of the application program. The design manner wastes much time and only focuses on single application software without efficiency.
(3) There is a restriction in use when a conventional way is applied to produce the recognition application software system. When the recognition application software system has to modify the reaction for a recognition outcome or an interface environment, the source codes must be rewritten or recompiled.

To satisfy the above generic interfaces integrating the recognition apparatus with the application program, the inventor of the present invention based on years of experience on related research and development to invent an interface system, a method and an apparatus to overcome the foregoing shortcomings.

### SUMMARY OF THE PRESENT INVENTION

It is an aspect of the present invention to provide an interface system, a method and an apparatus. A visual user interface with simple and effective operation is provided especially for a user that integrates a recognition apparatus with an application program.

Accordingly, the interface system of the present invention is applied for an electronic apparatus. The interface system comprises a load module, an instruction database, a macro module, an object module, a command input module and a processing module. The load module is to load a recognition apparatus and an application program. The instruction database comprises a plurality of action instructions, and each one action instruction corresponds to an operation action of the application program. A plurality of macro instructions is set by the macro module to perform one group of operation actions of the application program, and each one macro instruction corresponds to one group of action instructions. A relative position of the application program is set by the object module to be an operation object controlled by the operation action. The command input module is coupled to the recognition apparatus, and is for inputting an input command generated from the recognition apparatus recognizing an action signal. A correspondence action Instruction Is obtained by the processing module from the instruction database based on the input command, then the operation action is performed in the application program which has been loaded, and the operation action corresponds to the action instruction.

The action signal can be an audio, an action, a pose, a facial impression or a color. The recognition apparatus can be an audio recognition apparatus, an action recognition apparatus, a pose recognition apparatus, a facial impression recognition apparatus or a color recognition apparatus. The electronic apparatus can be a personal computer, a server, a laptop computer, a personal digital assistant or a mobile telephone. In addition, a visual user interface is provided for setting the operation action of the application program.

The interface system, the method and the apparatus have the features as follow:
(1) A generic visual interface environment is provided, and a user could integrate the recognition apparatus with the application program through the interface.
(2) Other application programs are easily coupled for operating by using the visual interface environment, and there is no need to modify the source codes of the application program and system programs.
(3) The application program can be modified to be a recognition application software system with visual operation capability, and there is no need to rewrite and recompile the source codes of the application program.

The foregoing aspects and many of the attendant advantages of this invention will become more readily appreciated as the same becomes better understood by reference to the following detailed description, when taken in conjunction with the accompanying drawings, wherein:

### BRIEF DESCRIPTION OF THE DRAWINGS

FIG. 1 depicts a schematic diagram showing a conventional recognition application software system;

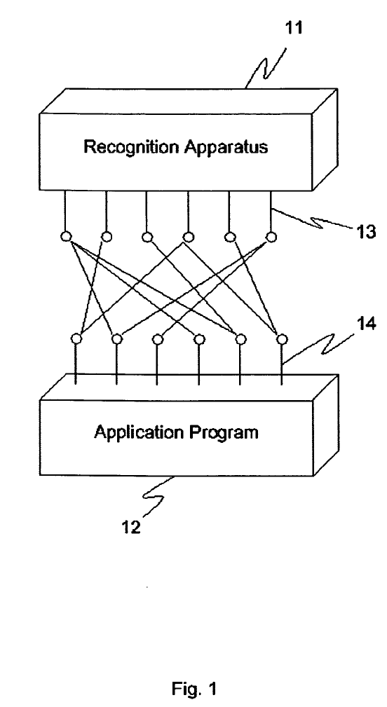

FIG. 2 depicts a block diagram showing an interface system in accordance with an embodiment of the present invention;

FIG. 3 depicts a flowchart showing an interface method in accordance with an embodiment of the present invention;

FIG. 4 depicts a block diagram showing an interface apparatus in accordance with an embodiment of the present invention; and

FIG. 5 depicts a block diagram showing the interface system in accordance with a preferred embodiment of the present invention.

### DETAILED DESCRIPTION OF THE PREFERRED EMBODIMENT

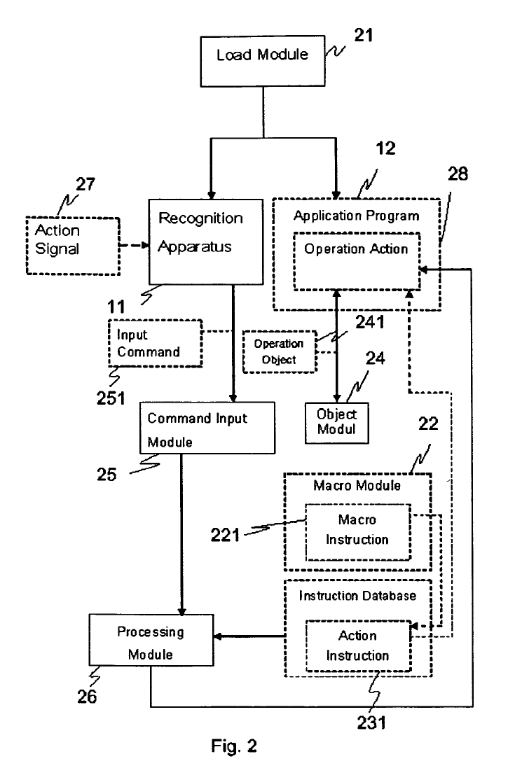

Reference is made to FIG. 2, which depicts a block diagram showing an interface system in accordance with an embodiment of the present invention. The interface system of the present invention comprises a load module 21, an instruction database 23, a macro module 22, an object module 24, a command input module 25 and a processing module 26. The load module 21 is for loading a recognition apparatus 11 and an application program 12. The instruction database 23 comprises a plurality of action instructions 231, and each one action instruction 231 corresponds to an operation action 28 of the application program 12. The macro module 22 is for setting a plurality of macro instructions 221 to perform one group of operation actions 28 of the application program 12, and each one macro instruction 221 corresponds to one group of action instructions 231. The object module 24 is for setting a relative position of the application program 12, and the relative position is used to be an operation object 241 controlled by the operation action 28. The command input module 25 is coupled to the recognition apparatus 11 and is for inputting an input command 251 generated from the recognition apparatus 11 recognizing an action signal 27. A correspondence action instruction 231 is obtained by the processing module 26 from the instruction database 23 based on the input command 251, the operation action 28 corresponding to the action instruction 231 is performed in the application program 12 which has been loaded.

The action signal 27 can be an audio, an action, a pose, a facial impression or a color. The recognition apparatus 11 can be an audio recognition apparatus, an action recognition apparatus, a pose recognition apparatus, a facial impression recognition apparatus or a color recognition apparatus. In addition, a visual user interface is provided to set the operation action 28 of the application program 12.

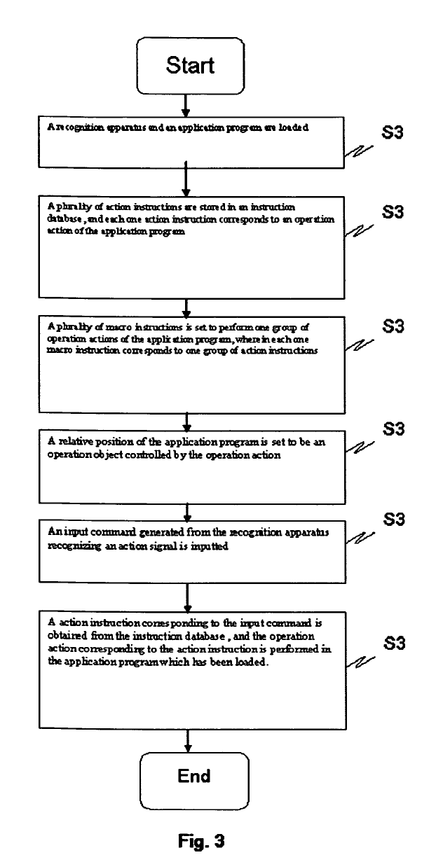

Reference is made to FIG. 3, which depicts a flowchart showing an interface method in accordance with an embodiment of the present invention. The interface method comprises the steps as follows:

Step S31: a recognition apparatus and an application program are loaded;

Step S32: a plurality of action instructions is stored in an instruction database, and each one action instruction corresponds to an operation action of the application program;

Step S33: a plurality of macro instructions is set to perform one group of operation actions of the application program, wherein each one macro instruction corresponds to one group of action instructions;

Step S34: a relative position of the application program is set to be an operation object controlled by the operation action;

Step S35: an input command generated from the recognition apparatus recognizing an action signal is inputted;

Step S36: a correspondence action instruction is obtained from the instruction database based on the input command, and the operation action corresponding to the action instruction is performed in the application program which has been loaded.

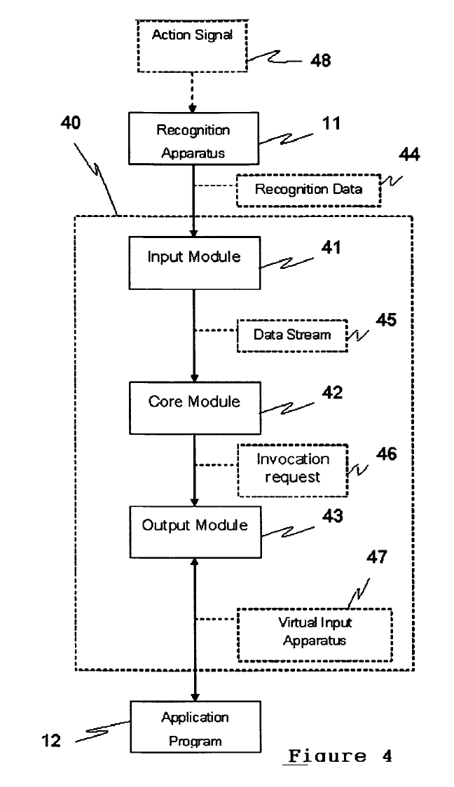

Reference is made to FIG. 4, which depicts a block diagram showing an interface apparatus in accordance with an embodiment of the present Invention. The interface apparatus 40 comprises an input module 41, a core module 42 and an output module 43. The input module 41 is for inputting a recognition data 44 generated from the recognition apparatus 11 recognizing an action signal 48, and the recognition data 44 is transformed into a data stream 45 for system compatibility. The core module 42 is to perform a syntax analysis and a compilation for the data stream 45, and an invocation request 46 is brought. The output module 43 is for driving a virtual input apparatus 47 based on the invocation request46, so as to operate an application program 12.

The action signal 48 can be an audio, an action, a pose, a facial impression or a color. The recognition apparatus 11 can be an audio recognition apparatus, an action recognition apparatus, a pose recognition apparatus, a facial impression recognition apparatus or a color recognition apparatus. The electronic apparatus can be a personal computer, a server, a laptop computer, a personal digital assistant or a mobile telephone. The virtual input apparatus 47 can be a virtual mouse or a virtual keyboard.

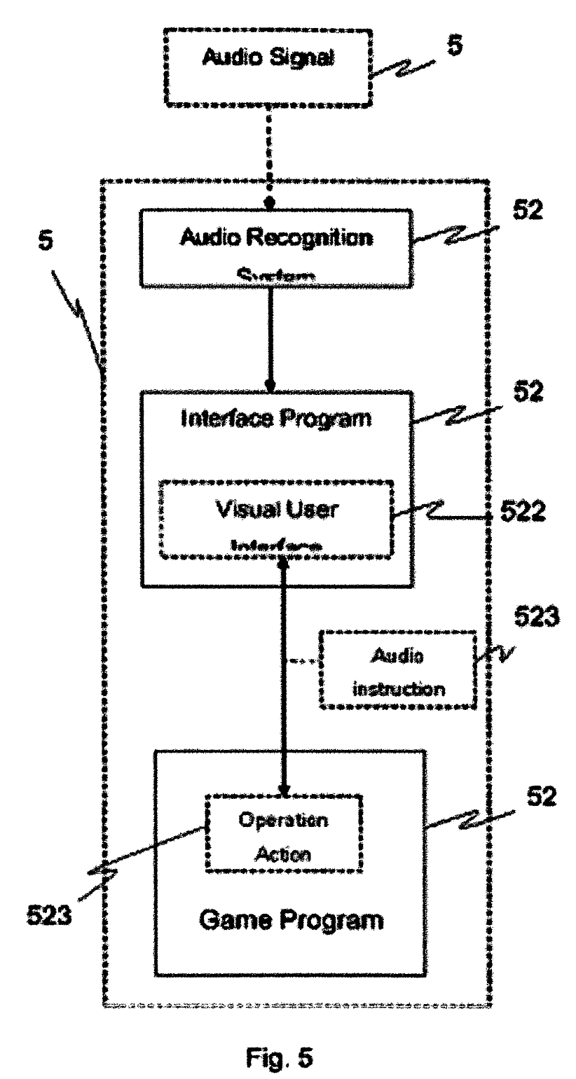

Reference is made to FIG. 5, which depicts a block diagram showing the interface system in accordance with a preferred embodiment of the present invention. The interface system comprises an audio recognition system 521, a game program 523 and an interface program 522. The audio recognition system 521 is for recognizing an audio signal 51 inputted by a user. The game program 523 is an application program. The interface program 522 is to load the audio recognition program 521 and the game program 523, and provide a visual user interface 5221. Then an audio instruction 5232 of a plurality of operation actions 5231 of the game program 523 is set and stored in order to establish a coupling between the audio recognition system 521 and the game program 523. Afterward, user can make a command through the audio signal 51. After recognizing by the audio recognition system 521, the command is then compared with an audio instruction 5232 in order to find a correspondence audio instruction 5232. An operation action 5231 corresponding to the audio instruction 5232 in the game program 523 is performed. Then, the game program 523 becomes a game program system 52 which has an audio recognition.

As is understood by a person skilled in the art, the foregoing preferred embodiments of the present invention are illustrated of the present invention rather than limiting of the present invention. It is intended that various modifications and similar arrangements be included within the spirit and scope of the appended claims, the scope of which should be accorded the broadest interpretation so as to encompass all such modifications and similar structure.

What is claimed is:

1. An interface system for an electronic apparatus, the interface system comprising:
a load module loading a recognition apparatus and an application program;
a instruction database having a plurality of action instructions, each one of the plurality of action instructions corresponding to an operation action of the application program;
a macro module setting a plurality of macro instructions, wherein the macro instruction is used to perform one group of operation actions of the application program, and each one of the plurality of macro instructions corresponds to one group of the plurality of action instructions;
an object module setting a relative position of the application program to be operation objects controlled by the operation actions;
a command input module coupling the recognition module for inputting an input command generated from the recognition module recognizing an action signal; and
a processing module obtaining a action instruction corresponding to the input command from the instruction database based on, and performing a operation action corresponding to the action instruction in the application program.

2. The interface system of claim 1, wherein the action signal is selected from an audio, an action, a pose, a facial expression and a color.

3. The interface system of claim 1, wherein the recognition apparatus is selected from an audio recognition apparatus, an action recognition apparatus, a pose recognition apparatus, a facial expression recognition apparatus and a color recognition apparatus.

4. The interface system of claim 1, wherein the electronic apparatus is selected from a personal computer, a server, a laptop computer, a personal digital assistant and a mobile telephone.

5. The interface system of claim 1, wherein the interface system further comprises a visual user interface for setting the plurality of operation actions of the application program.

6. An interface method for an electronic apparatus, the interface method comprising:
loading a recognition apparatus and an application program;
storing a plurality of action instructions in an instruction database, each one of the plurality of action instructions corresponding to an operation action of the application program;
setting a plurality of macro instructions, wherein the macro nstruction is used to perform one group of operation actions of the application program, and each one of the plurality of macro instructions corresponds one group of action instructions;
setting a relative position of the application program to be operation objects controlled by the operation actions;
inputting an input command generated from the recognition apparatus recognizing an action signal;
obtaining a action instruction corresponding to the input command from the instruction database, and performing a operation action corresponding to the action instruction in the application program.

7. The interface method of claim 6, wherein the action signal is selected from an audio, an action, a pose, a facial expression and a color.

8. The interface method of claim 6, wherein the recognition apparatus is selected from an audio recognition apparatus, an action recognition apparatus, a pose recognition apparatus, a facial expression recognition apparatus and a color recognition apparatus.

9. The interface method of claim 6, wherein the electronic apparatus is selected from a personal computer, a server, a laptop computer, a personal digital assistant and a mobile telephone.

10. The interface method of claim 6, wherein the interface system further comprises a visual user interface for setting the plurality of operation actions of the application program.

11. An interface apparatus for an electronic apparatus, the electronic apparatus setting a recognition apparatus to recognize an action signal and generating a recognition data, the interface apparatus comprising:
an input module inputting the recognition data, and transforming the recognition data into a data stream for system compatibility;
a core module performing a syntax analysis and a compilation for the data stream, and bringing an invocation request; and
an output module driving a virtual input apparatus based on the invocation request to operate an application program.

12. The interface apparatus of claim 11, wherein the action signal is selected from an audio, an action, a pose, a facial expression and a color.

13. The interface apparatus of claim 11, wherein the recognition apparatus is selected from an audio recognition apparatus, an action recognition apparatus, a pose recognition apparatus, a facial expression recognition apparatus and a color recognition apparatus.

14. The interface apparatus of claim 11, wherein the electronic apparatus is selected from a personal computer, a server, a laptop computer, a personal digital assistant and a mobile telephone.

15. The interface apparatus of claim 11, wherein the virtual input apparatus is selected from a virtual mouse and a virtual keyboard.
